(19) United States
(12) Patent Application Publication
(10) Pub. No.: US 2015/0079561 A1
(43) Pub. Date: Mar. 19, 2015

(54) GENERATING, DISPLAYING, AND TRACKING OF WELLNESS TASKS

(71) Applicants: Artem Petakov, New York, NY (US); Mark Simon, New York, NY (US); Ketill Gunnarsson, Trnava (SK); Chow Lin, New York, NY (US); Gennady Shafranovich, Brooklyn, NY (US)

(72) Inventors: Artem Petakov, New York, NY (US); Mark Simon, New York, NY (US); Ketill Gunnarsson, Trnava (SK); Chow Lin, New York, NY (US); Gennady Shafranovich, Brooklyn, NY (US)

(73) Assignee: WorkSmart Labs, Inc., New York, NY (US)

(21) Appl. No.: 14/345,047

(22) PCT Filed: Sep. 14, 2012
(86) PCT No.: PCT/US12/55548

§ 371 Date: Nov. 20, 2014

Related U.S. Application Data
(60) Provisional application No. 61/534,855, filed on Sep. 14, 2011.

(51) Int. Cl. G09B 19/00; G01G 19/44

(52) U.S. Cl. CPC G09B 19/00; G01G 19/44
USPC 434/236

(57) ABSTRACT

A method of facilitating a completion of a wellness task is disclosed. A goal pertaining to a health of a user is determined. Information is identified that is to be collected to determine a progress of the user toward accomplishing the goal. A level of specificity at which to prompt the user to provide a portion of the information is selected. The user is prompted to provide the portion of the information at the level of specificity. A progress of the user toward accomplishing the goal is determined based on the portion of the information.

### RELATED APPLICATIONS

This application claims the benefit of U.S. Provisional Application No. 61/534,855, filed Sep. 14, 2011, entitled “METHOD AND SYSTEM FOR GENERATING, DISPLAYING, AND TRACKING OF WELLNESS TASKS IN THE COURSE OF AN ELECTRONIC HEALTH PROGRAM,” which is incorporated herein by reference in its entirety.

### BACKGROUND

Compliance is one of the hardest problems for almost any modern health or wellness program. This is true in every program requiring extended effort—from taking pharmaceuticals for specific conditions to much more abstract wellness goals, such as weight loss, muscle gain, a healthy lifestyle, etc. Compliance is especially difficult when there are multiple ways to achieve a particular health or wellness goal, so the indecision and confusion cause a drastic reduction in compliance and in the eventual outcomes. A program may focus on a journal or diary metaphor. In such a program, a user may simply “journal” (e.g., write down) what he does in the real world. A system may generate and present graphs and charts that help a user examine recorded patterns and possibly make behavior modifications based on the recorded patterns. Or a system may function as a “customized program,” akin to a custom prescription a person may receive after a visit to, for example, a physician or physical therapist. Here, the system may receive information about the user and, based on the information, create a custom program for the user to follow or enable the user to select a custom program from a set of custom programs. The paradigms of these systems may have various limitations. For example, such systems may appear robotic or synthetic to the user.

### BRIEF DESCRIPTION OF THE DRAWINGS

FIG. 1 is a network diagram depicting a client-server system within which various example embodiments may be deployed.

FIG. 2 is a block diagram depicting example modules of the applications of FIG. 1 that are configured to implement an abstraction of a personal trainer.

FIG. 3 is a flowchart depicting an example embodiment of a method of maintaining a compliance of a user with a program.

FIG. 4 is a flowchart depicting an example embodiment of a method 400 of maintaining a compliance of a user with a program.

FIG. 5 is an interaction diagram depicting example interactions between a client and a server in automatic goal generation and human-generated goal generation.

FIG. 6 is a block diagram depicting an example flow of the applications 120, which are configured to implement a task-based electronic health program.

FIG. 7 is a screenshot depicting an example user interface for presenting a user with information concerning his health program.

FIG. 8 is a screenshot depicting an example user interface for prompting a user to provide detailed information regarding what he has eaten.

FIG. 9 is a screenshot depicting an example user interface for prompting a user to provide summary information regarding what he has eaten.

FIG. 10 is a screenshot depicting an example user interface for prompting a user to enter information regarding his exercise activities.

FIG. 11 is a screenshot depicting an example user interface for gathering information about a workout.

FIG. 12 is a screenshot depicting an example user interface for presenting a user with an exercise task and prompting the user to specify whether he has completed the task.

FIG. 13 is a screenshot depicting an example user interface for presenting a user with a mini-article task.

FIG. 14 is a screenshot depicting an example user interface for prompting a user to commit to performing a task in the future.

FIG. 15 is a screenshot depicting an example user interface in which a widget is displayed outside of the context of the user accessing the applications of FIG. 1.

FIG. 16 is a screenshot depicting an example user interface for enabling a user to communicate directly with a human trainer.

FIG. 17 is a screenshot depicting an example user interface for enabling a user to communicate with a human trainer.

FIG. 18 is a block diagram depicting example relationships between tables of databases used by the applications of FIG. 1.

FIG. 19 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

In various embodiments, methods and systems of providing an abstraction of a personal trainer (or coach) are provided, wherein a user may receive the right instructions, at the right time, with the right reinforcement, to make sure that the user adheres to a program. The program may be adjusted along the way. As a result, both user compliance and an eventual success of the program may be improved.

In various embodiments, methods and systems of facilitating a completion of a wellness task are disclosed. A goal pertaining to a health of a user is determined. Information is identified that is to be collected to determine a progress of the user toward accomplishing the goal. A level of specificity at which to prompt the user to provide a portion of the information is selected. The user is prompted to provide the portion of the information at the level of specificity. A progress of the user toward accomplishing the goal is determined based on the portion of the information.

The methods and the various embodiments disclosed herein may be implemented as a computer system having one or more modules (e.g., hardware modules or software modules). The methods and the various embodiments disclosed herein may be embodied as instructions stored on a machine-readable medium that, when executed by a processor, cause the processor to perform the methods.

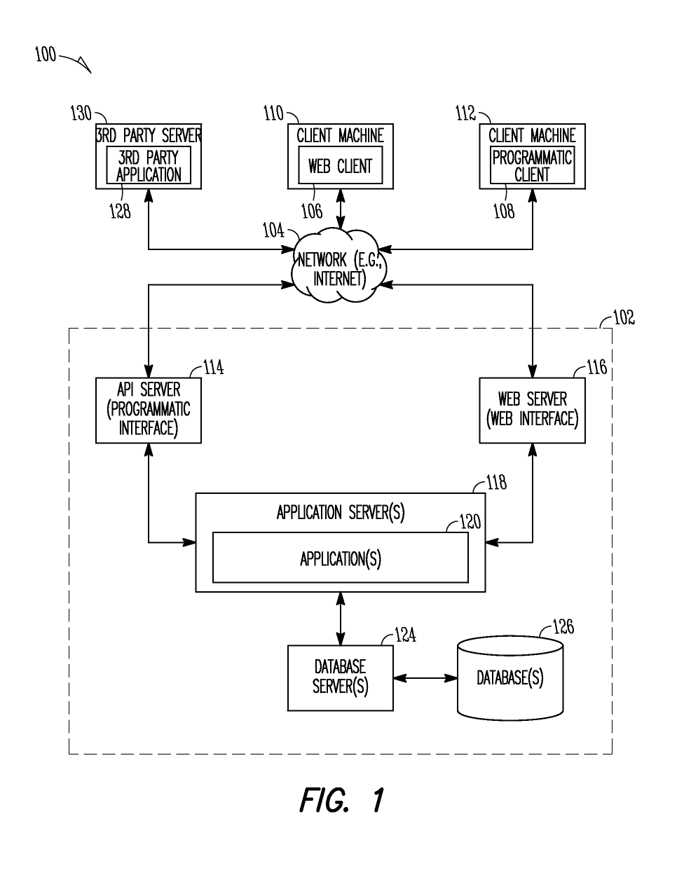

FIG. 1 is a network diagram depicting a client-server system 100, within which various example embodiments may be deployed. A networked system 102 provides server-side functionality via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 (e.g., an Android or iPhone application) executing on respective client machines 110 and 112.

An API server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases or NoSQL or non-relational data stores 126.

While the system 100 shown in FIG. 1 employs a client-server architecture, various embodiments are, of course, not limited to such an architecture, and could equally well find application in a distributed, or peer-to-peer, architecture system, for example. The various applications 120 may also be implemented as standalone software programs, which do not necessarily have networking capabilities. Additionally, although FIG. 1 depicts machines 130, 110, and 112 as being coupled to a single networked system 102, it will be readily apparent to one skilled in the art that machines 130, 110, and 112, as well as applications 128, 106, and 108, may be coupled to multiple networked systems. For example, the application 128, 106, and 108 may be coupled to multiple payment applications associated with multiple payment processors (e.g., Visa, MasterCard, and American Express).

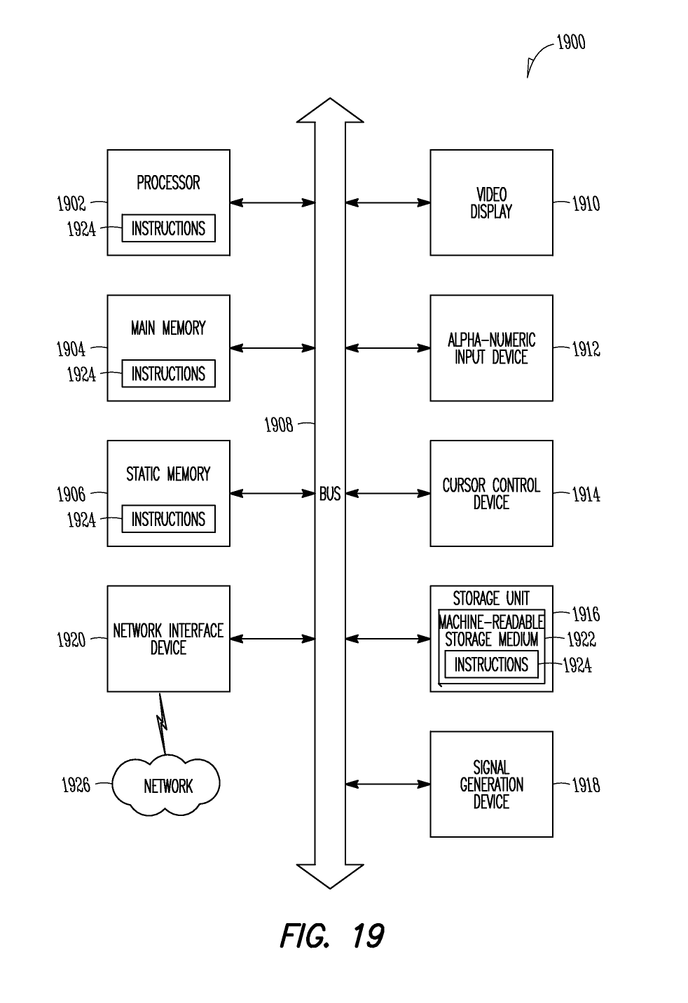

The web client 106 accesses the applications 120 via the web interface supported by the web server 116. Similarly, the programmatic client 108 accesses the various services and functions provided by the applications 120 via the programmatic interface provided by the API server 114. An example architecture of a machine on which a client or server may execute is described with respect to FIG. 19.

In various embodiments, the web server 116 is an Apache Web Server and the database server 124 is a mySQL relational database management system (RDMS).

In various embodiments, as described in more detail below, the client presents a task-based user interface to a user, collects data either implicitly through the client sensors or explicitly through data entry, presents the user articles, challenges, and so on. Some clients, such as clients executing on Android mobile phones, may implement push technology that allows a server (e.g., API server 114) to push information to the client. This push technology may be used by one or more applications (e.g., applications 120) to notify a client (e.g., client 128, 106, or 108) of new or updated task. On other clients, notifications may be implemented through polling by a memory-resident program. Clients may send collected data to the server for backup and analysis purposes. An application (e.g., applications 120) executing on a server may handle data analysis, backup, and task generation. Generating an efficient curated set of tasks in the correct order based on user interaction may be a complex process.

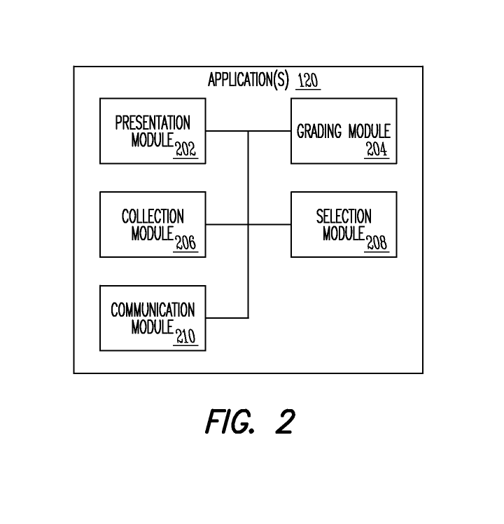

FIG. 2 is a block diagram depicting example modules of the applications 120 that are configured to implement an abstraction of a personal trainer.

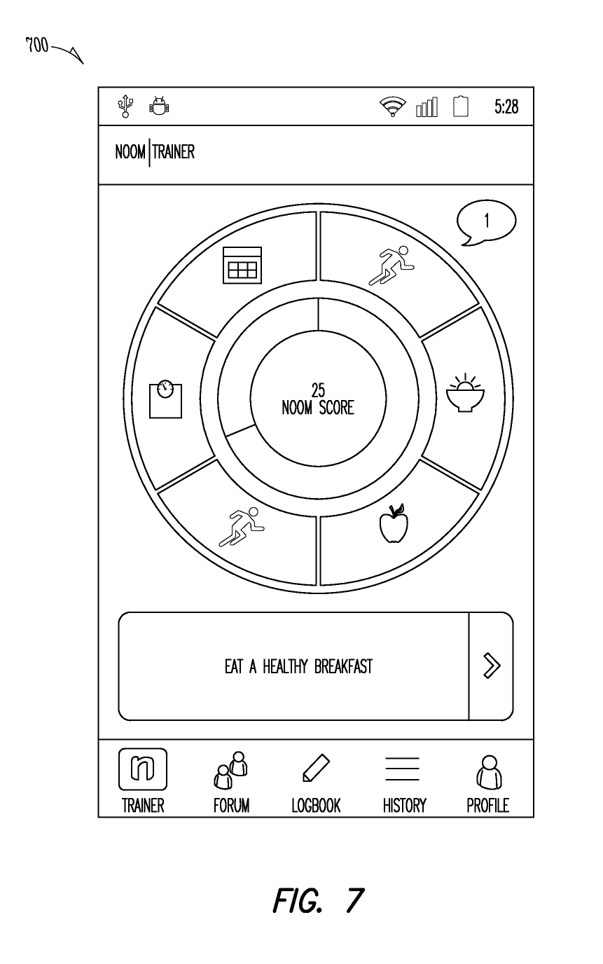

A presentation module 202 presents a user with a set of daily tasks. In various embodiments, these tasks may be represented graphically on a task wheel, such as the task wheel depicted in FIG. 7.

A grading module 204 grades the user as he makes progress toward completing each of these tasks. The grading module 204 may show the status of each task on the wheel.

A collection module 206 collects information about the user, such as information on what goal or goals the user is trying to achieve (e.g., weight loss, reduction in back pain, etc.). Such information is either collected from information provided explicitly or implicitly from the user through manual or automatic journaling. The collection module 206 may collect data from the user over time and adjusts the tasks based on the data obtained from the user. Thus, the program may be customized not only based on information received from the user at the start of the program, but also based on information received from the user as the user participates in the program.

A selection module 208 selects an optimal set of daily tasks for the user based on information that the coach receives about the user. A selection algorithm may limit the number of tasks (e.g., to 8-10 tasks per day) based on a determination of an optimal number of tasks that will enable the user to reach his goal while maximizing the user's compliance with the program. This determination may be based on information received from the collection module 206 concerning the user's goals and the user's past history with respect to completing suggested tasks. The selection algorithm is described in more detail below.

A communication module 210 communicates with the user (e.g., to simulate an interaction of the user with a personal trainer). For example, the communication module 210 may send messages to the user indicating the user's progress toward completing tasks or reaching a goal. Or the communication module 210 may send a message explaining one or more reasons for a selection by the selection module 206 of a specific task for the user to perform. In various embodiments, the communication module 210 sends messages to the user automatically (e.g., without incorporating input from an actual human person). In other embodiments, the communication module 210 incorporates or directly sends messages to the user from an actual human person.

The communication module 210 may determine how much input to incorporate from an actual human person based on various factors. For example, the communication module 210 may balance a demand (e.g., based on requests) from users to receive input from human people with a supply of such input available from human people. In various embodiments, the communication module 210 may incorporate just enough input from an actual human person into communications with a user to ensure that the user receives a level of human interactivity necessary to improve user compliance without exceeding an ability of available humans to provide that level of human interactivity. Thus, in various embodiments, the communication module 210 may communicate with the user at a level of automaticity at which the communications not only do not appear to the user to be robotic or inflexible but also do not require constant human interaction.

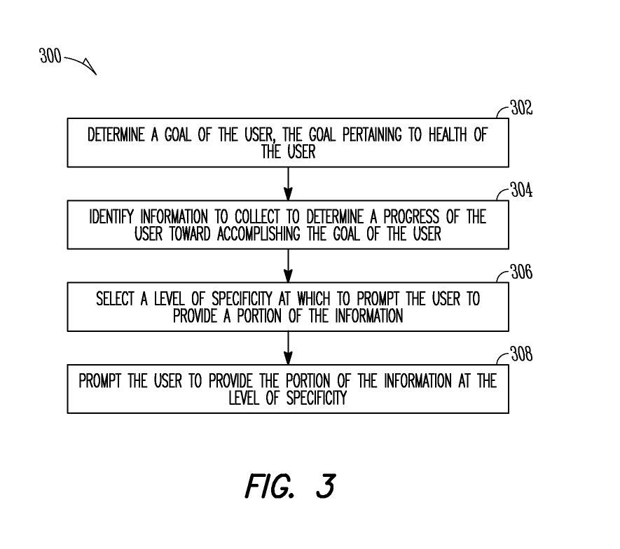

FIG. 3 depicts an example embodiment of a method 300 of maintaining a compliance of a user with a program. In various embodiments, the method 300 may be implemented by the applications 120. At operation 302, the collection module 206 determines a goal of the user, the goal pertaining to health of the user. At operation 304, the collection module 206 identifies information to collect to determine a progress of the user toward accomplishing the goal of the user. The collection module 206 may collect data from the user over time and adjust tasks (e.g., selected by the selection module 208) based on the data obtained about the user. In other words, the program may be customized based on data collected throughout the lifetime of the program in addition to any data collected about the user at the start of the program.

The selection module 208 may generate or select from many (e.g., hundreds or thousands) of different tasks on the path to a goal. However, the selection module 208 may only present a subset of those tasks to a user over a given time period. For example, the selection module 208 may only present 8-10 tasks to the user per day. The selection module 208 may select and determine a sequence of tasks to present to the user based on a determination by the selection module 208 of which tasks and order of tasks are most likely to increase user compliance with the program.

The selection module 208 may have great flexibility in “asking” the user to do a variety of different tasks (e.g., via a user interface). These tasks may have various types. For example, a task may be an explicit data collection task, a manual journaling task, an automatic tracking task, a read mini-article task, a mini-challenge task, or a scheduling/future commitment task. The selection module 208 may be configured to generate or select tasks of these types as well as other types.

Explicit Data Collection Task: one of the simplest task types, this task asks a user an explicit question or set of questions. This can be a question about a measurement from an external tool or sensor (e.g., scale or glucose meter), a question about behavior of a user in the past, behavior about user preferences for certain tasks, or any other general question. Questions may be in a multiple choice format, a freeform entry format, or a combination of these formats or others.

Manual Journaling Task: this is somewhat similar to a data collection task, except that it requires a more general/undirected data collection mechanism. An example is asking a user to log the full details of their breakfast, lunch and dinner. These tasks may require a large amount of effort from the user, because they may collect a lot of information, and only some of the information may be used by the applications 120 later. Instead of requiring the user to journal everything, the selection module 208 may select a task that asks the user to journal only at specific occasions. Additionally, the selection module 208 may select tasks that ask the user to provide information at various levels of detail based on the information that would best help the applications 120 to, for example, determine a progress of the user toward reaching a goal or generate tasks to select additional tasks that would be most likely to help the user reach his goal while at the same time maintaining his compliance with the program. For example, the selection module 208 may select tasks involving detailed journaling once a week. On other days, the selection module 208 may estimate detailed journaling based on user behavior (or habits) or data or variables, such as data collected implicitly by the collection module 206.

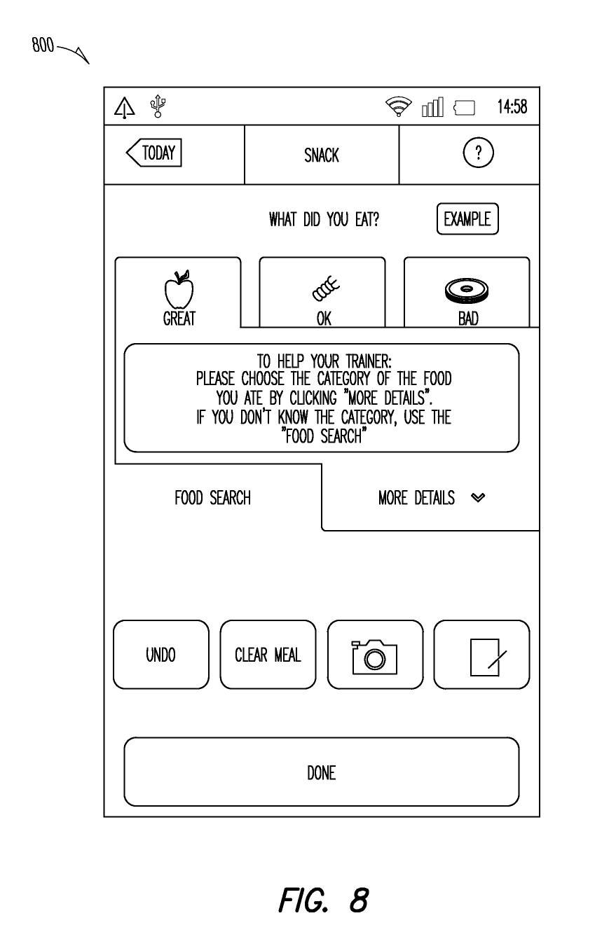

Meal Logging tasks may be used to illustrate the relevant concepts. The selection module 208 may initially select a task having a detailed logging level based on the selection module 208 lacking information about what in particular the user is eating, so that later the selection module 208 may select the correct foods to help him lose weight. The selection module 208 may select a task having this detailed logging level only several times a month, just enough to learn what recommendations to make to a user. FIG. 8 depicts an example user interface via which the collection module 206 may ask the user for this detailed information.

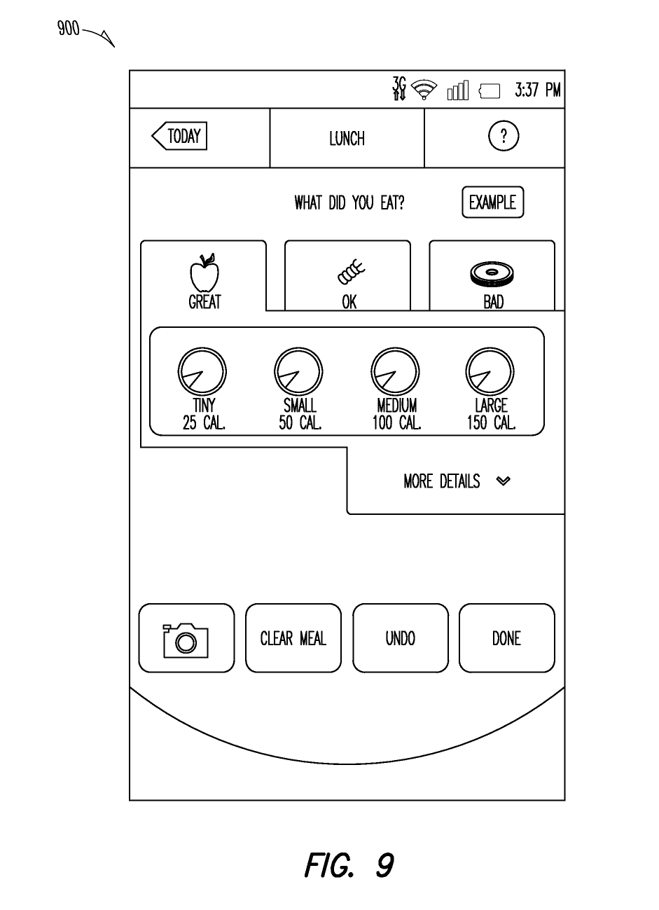

At other times, the selection module 208 may select a task having a less-detailed logging level. For example, the selection module 208 may select a task in which the user provides an approximate food quality of the items he is eating. FIG. 9 depicts an example user interface via which the collection module 206 may ask the user for this less-detailed information. The selection module 208 may select this type of less-detailed journaling more frequently because it encourages responsible eating without a big burden. The selection module 208 may fill in the blanks in data concerning the user's progress toward accomplishing goals based on various additional information collected about the user, such as the user's weight. For example, the selection module 208 may determine that the user's diet has not changed based on the user's weight remaining constant. Or the selection module 208 may determine that the user's diet has changed based on fluctuation in the user's weight. In this case, if the user's weight is fluctuating, the selection module 208 may select more detailed journaling tasks for the user to perform or increase a frequency at which the user is requested to complete journaling tasks.

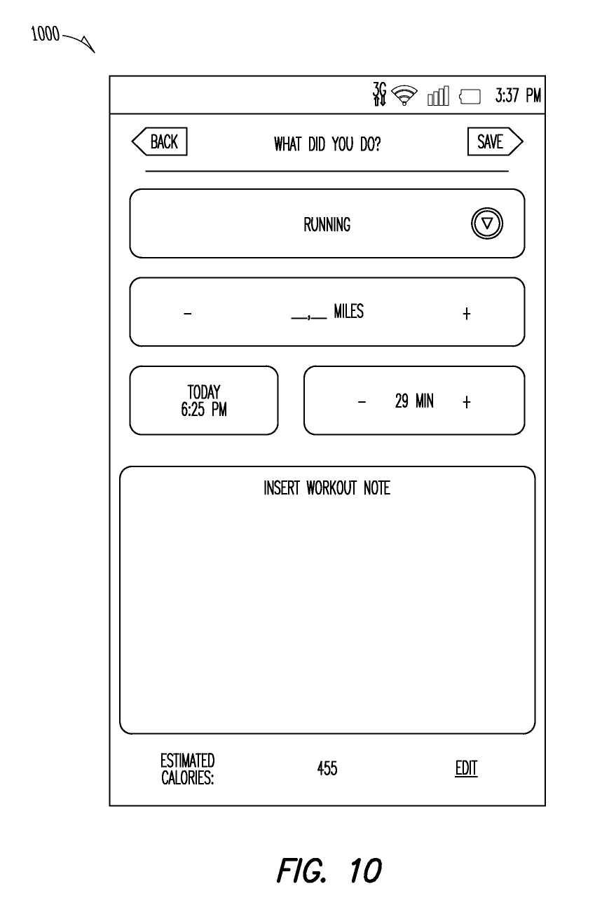

Exercise logging tasks may also be used to illustrate selections of journaling tasks pertaining to exercising that have different levels of detail. For example, FIG. 10 depicts example user interfaces through which the collection module 206 may collect more- or less-detailed information about the user's exercising (e.g., via manually logging).

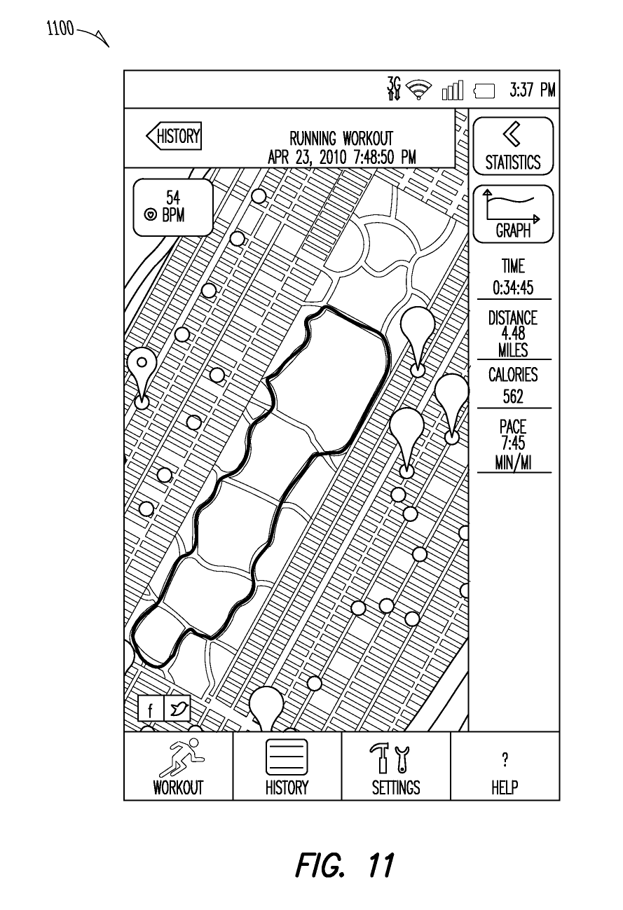

Automatic Tracking Task: this task is similar to the journaling task, except it does not require the user to explicitly enter the data and instead relies on the measurements from external sensors or sensors available on a device associated with the user. For example, in the current embodiment, running on a mobile phone, the “Walk for 10 minutes” task uses the phone's accelerometer and GPS sensors and combines their measurements for better accuracy (and reliability in case GPS signal is lost) (see FIG. 11.). If the exercise type is dancing, the phone may only use the accelerometer and in a different mode. Some automatic tracking tasks do not even require the user to start the tracking, but rather are constantly tracking—these are some of the most desirable goals. A power efficient pedometer may be used to constantly monitor walking.

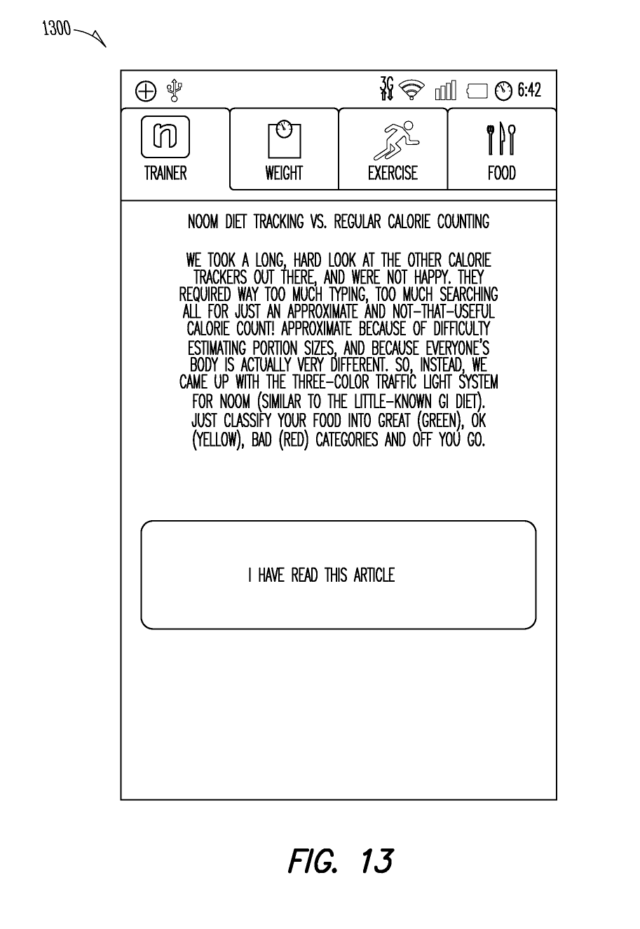

Read Mini-Article Task: this task educates a user about a particular topic that is relevant to achieving his goal. For example, if a person is trying to lose weight, this article can be about “Dangers of Diet Soda.” In various embodiments, the articles are triggered based on user feedback on others tasks (e.g., a Journaling Task). The mini-article task presents a user with some text and with a button “I have read this” (see FIG. 13). In other embodiments, the invention presents the user with a mini-test after reading the article.

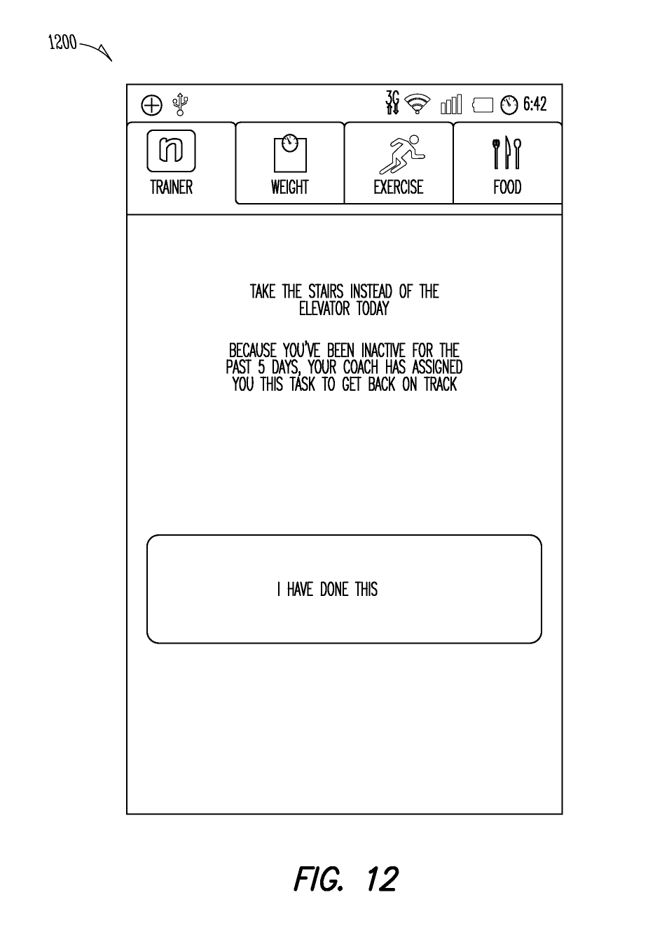

Mini-Challenge Task: this task is similar to a mini-article task, but instead asks the user to perform a certain action. For example, “Take the stairs instead of the elevator” (see FIG. 12). In one embodiment, these tasks are triggered based on feedback provided on other tasks (e.g. Journaling or Explicit Data Collection Task). The mini-challenge task presents a user with a description of the challenge and a button “I did this.” In other embodiments, the invention uses the automated tracking capabilities to keep track of task completion.

Scheduling/Future Commitment Task: this task asks a user to plan for the future or to simply commit to a particular goal in the future. “Pre-Commitment” is a powerful behavior change technique, which allows people to commit to tasks when they seem far in the future (e.g., as with setting an alarm clock early in the evening, even if one knows it will be hard to get up in the morning).

One example of such a task in is a “grocery shopping day.” The collection module 206 asks the user what day he would be able to go grocery shopping, and then, based on the answers, the selection module 208 schedules a “Healthy Grocery Shopping” goal on the appropriate day.

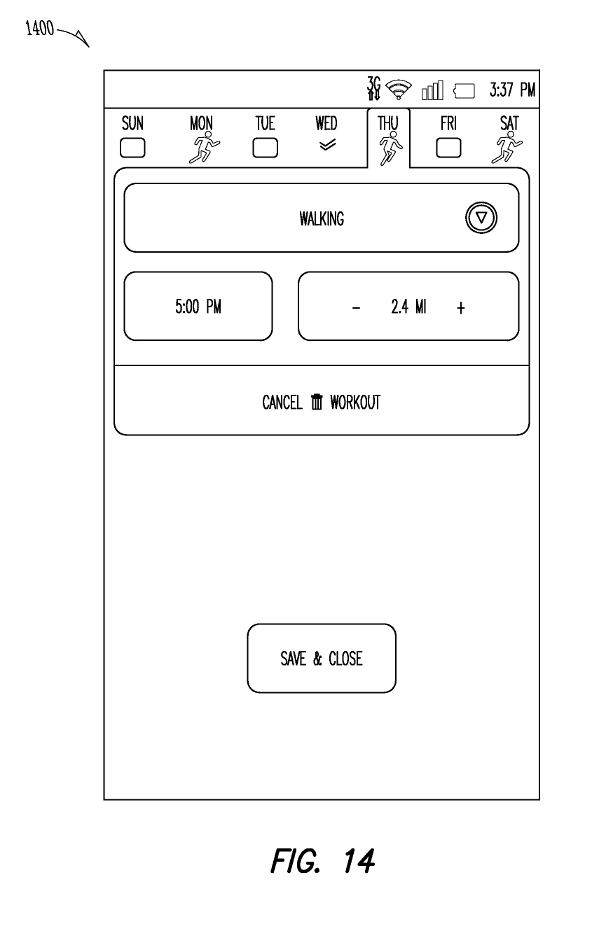

Another example is the “setup exercise schedule” goal (see FIG. 14), which asks a user to commit to an exercise schedule that he will follow later. After scheduling, and if the user had trouble following the commitment in the past, the selection module 208 schedules another Commitment Goal to reaffirm the person's willingness to do the goal in the future.

Referring back to FIG. 3, at operation 306, the selection module 208 selects a level of specificity at which to prompt the user to provide a portion of the information (e.g., via the collection module 206). As described above, the level of specificity may be based on information that the selection module 208 lacks (e.g., via implicit or explicit collection of additional data) with regard to a user's progress toward completing a task.

At operation 308, the collection module 206 prompts the user to provide the portion of the information at the level of specificity (e.g., via a user interface).

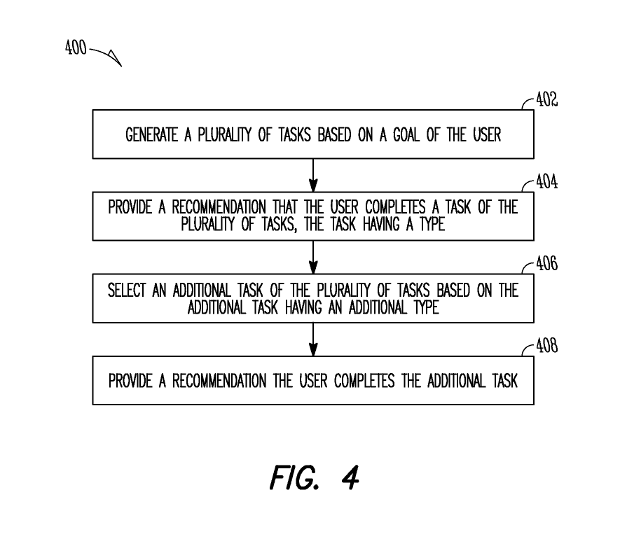

FIG. 4 depicts an example embodiment of a method 400 of maintaining a compliance of a user with a program. At operation 402, the selection module 208 generates a plurality of tasks based on a goal of the user. At operation 404, the communication module 210 provides a recommendation that the user completes a task of the plurality of tasks, the task having a type. At operation 406, the selection module 208 selects an additional task of the plurality of tasks based on the additional task having an additional type. At operation 408, the communication module 210 provides a recommendation that the user completes the additional task. In this way, the applications 120 may suggest a variety of different types of tasks for the user to perform in a given time period, which, in turn, may increase user compliance with the program.

In addition to generating and presenting different task types to the user, the invention scores each task as the user completes it. The exact scoring method may be important to shaping behavior patterns.

In various embodiments, the grading module 204 uses a score out of a maximum 100 points that resets to 0 every day. For each task that a user completes, he receives a fraction of the 100 points. If he completes all of tasks fully, the user will receive the whole 100 points. The fraction of 100 points assigned to each task may represent an importance of this task in achieving the user's desired goal/outcome. For example, if a user's goal is weight loss, goals related to diet would receive a larger percentage of the circle than those related to exercise, thus giving the user insight that completing his diet tasks is more important.

As soon as the user receives all of the points, the user may be done for the day, and this done status may be clearly shown to them. In other words, the user may not be encouraged to do as much as possible (e.g., journal as much food or exercise is possible), but just complete a particular set of tasks. In this way, the grading module 204 takes into account that a user may fall prey to “overdoing-it” by doing too much over a short time period. However, the grading module 204 may allow the user to go beyond the allotted tasks within reasonable bounds. Specifically, the grading module 204 may set aside 20 points of extra credit for additional tasks a user might choose to do.

Instead of motivating users around a particular single metric (such as calories burned), which may not reflect the wide spectrum of behaviors required from the user to achieve the desired goal or difficulty different people might have in achieving the single metric, the grading module 204 makes the score comparable across individuals in terms of effort.

The grading module 204 may combine individual daily scores into weekly scores and total scores by summing them. This allows the user to see and measure long-term progress towards their goal, and thus serves as a simple motivation to continue longer.

Beyond the grading mechanism, various embodiments of the applications 120 use a variety of other mechanisms to encourage the user to complete the assigned tasks.

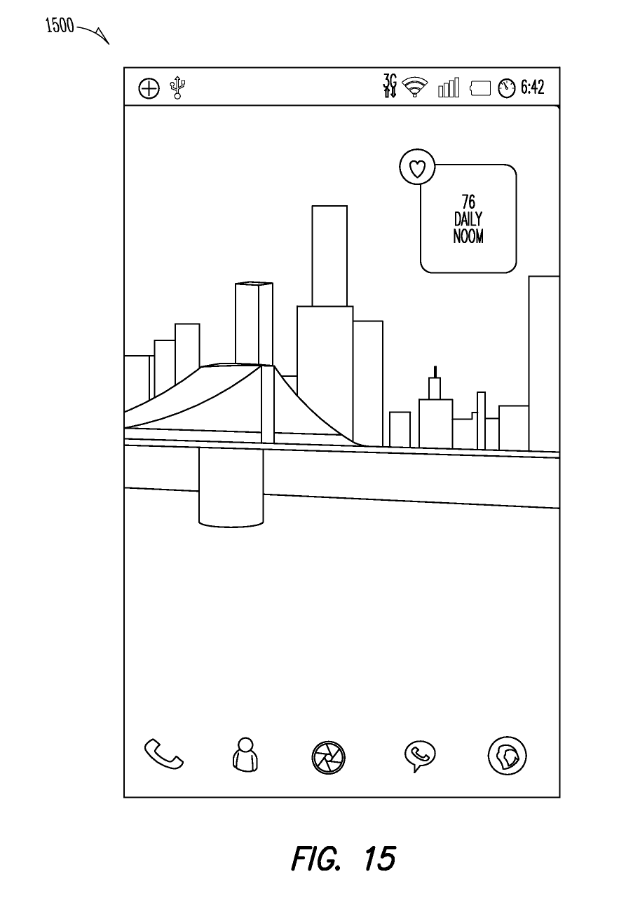

FIG. 15 depicts a screenshot of an example embodiment of a user interface 1500 containing a widget. The widget is a miniaturized representation of the daily score which appears to the user even when the user is not accessing the applications 120 (e.g., via a client application on a mobile device), and thereby encourages them to see the score more frequently, which improves compliance. In this embodiment, the widget is implemented as an Android widget, but it can be implemented using any embedding technology such as an iframe or other method of RPC in an HTML5 implementation, as long as such a display shows the user the score in a miniaturized way and outside of the normal client application.

Additionally, in various embodiments, the applications 120 use different mechanisms to apply social pressure on the user. For example, the communication module 210 may enable the user to designate a supporter (or “buddy”), who gets notified every time the user receives new tasks to complete, as well as when the user completes the tasks. The frequency of notification can be customized by the supporter, and can range from hourly to monthly. The buddy may be a close friend or spouse, who can provide both psychological support and actual support for the program (e.g., by cooking healthier meals or going for walks together).

As another example, the communication module 210 may integrate the applications 120 with an electronic support group. This electronic support group may be a small group of users who are placed into a group based on common goals and demographic characteristics (e.g., all females who want to lose 10-20 lbs. and are over 40 years old). With the user's permission, such a group may also have access to the daily, weekly and total scores of the particular user and all of his assigned and completed tasks. This group may provide additional peer pressure to encourage compliance, as well as advice from personal experience, as a traditional support group would. The users have access to a group forum where they all communicate with one another. A user interface presented by the communication module 210 via the client applications may display the daily, weekly and total scores next to each member, making these scores a “status symbol” for members of the group.

In various embodiments, the grading module 204 may incorporate a set of game mechanics to encourage “long-term” compliance. In one embodiment, such a mechanic can include a level system where each user starts at level 1, and each week with an average daily score of 80 or above, increases the level by 1, each week with score in range 50-80, the level stays constant and each week with a score below 50, the level drops by one. In addition, the user earns a “badge” for every week they get an average score of above 90. A badge may not be lost under any circumstances. Other embodiments can include other formulas for calculating levels and badges. Both levels and badges are prominently displayed to the user and the various types of supporters.

In various embodiments, the grading module 204 may improve motivation by giving the user extrinsic rewards in return for complying with tasks over the long-term. Such rewards include sponsored offers for meeting particular types of tasks (e.g., Nike shoe discount for doing 5 running tasks in a row), and for achieving a set of tasks for a predetermined duration (e.g., all goals for the last 5 days). Because the task infrastructure is flexible, the grading module 204 may motivate specific behaviors requested by advertising partners, and then reward users for achieving this behavior, all the in the natural context of complying with tasks.

In various embodiments, the task generation methodology (e.g., via the selection module 208) may be based on the health goal that the particular embodiment is trying to address. The following example pertains to a weight loss goal, but the same methodology and principles may be applied to other goals.

In various embodiments, the selection module 208 uses a combination of fixed tasks and “smart” conditional tasks to generate the full set of tasks for the user. Initially, the selection module 208 may not know any information about the user, so it may assign a set of fixed ramp-up tasks to collect basic information from the user (e.g., via the collection module 206). As the system learns more about the user, selection module 208 may enable the smart tasks take over from the fixed tasks and guide the user through the rest of the coaching program. A “smart” task is a task that is only generated when a particular condition is true. A trivial example of a smart task is a task that is scheduled because of a previous commitment. For example, if a person commits to going shopping every Friday, the invention generates the “Healthy Grocery Shopping” goal every Friday. To generate smart tasks, the selection module 208 may iterate over a set of smart task triggers and determine if the smart task should be scheduled.

An initial bootstrap fixed task sequence may include various tasks, as described below. However, it will be clear to one skilled in the art that particular tasks can vary substantially.

Day 1

1: Read the coach intro article (Article Task).

2: Fill out questionnaire about you and your specific wellness goals (Explicit Data Collection Task).

3: Log your lunch details using food journaling (Journaling Task, see FIG. 3).

4: Mini-challenge: take the stairs today. If you don't have stairs anywhere or it's too late in the day, do 20 jumping jacks right now instead. (Mini-Challenge Task).

Day 2

1: Eat 5 different non-fried vegetables today (Mini-Challenge Task).

2: Log your dinner details using food journaling (Journaling Task).

3: Read an article about minimum exercise baseline (Article Task).

4: Install the Noom widget on the home screen (Mini-Challenge Task/Motivation).

5: Go for a 5-minute walk (Automatic Tracking Task).

Day 3

1: Fill out a basic questionnaire about your diet habits (Explicit Data Collection Task).

2: Log your whole day with no details (Journaling Task).

3: Reconsider your exercise schedule (Mini-Challenge Task).

4: Schedule your grocery day (Future Commitment Task).

Conditional Task Generation (“Smart” Tasks)

After day 3, the selection module 208 begins to use smart (conditional) tasks. In other embodiments, there may be a longer fixed coaching sequence before this point.

1) The Food Journaling Smart Task encourages the user to provide information about different meals. It checks if a particular meal was logged less than 4 times in the last 10 days, then with probability 0.3, it schedules that meal to be logged.

2) The Food Mini-Article Smart Task encourages the user to eat healthy food. It does this by checking meal data in the last month, and collects all unique food items that a person has eaten, with a count of how many of each item the person ate. Then it sorts them based on this count, iterates over the list, and triggers an article related to that food. If this article has already been shown to the user, the next food item in the list is chosen. If an article is found, it is triggered with probability 0.8.

3) The Congratulations Smart Task triggers if the user has had 80 or higher score on each of the last 3 days. If the task triggers, it inserts a mini-article task that congratulates the user and encourages him to continue further in the program. This task may trigger with a particular probability (e.g., 0.8).

4) Survey Smart Task has a set of 5 surveys that trigger randomly (e.g., with a probability of 0.1) if the user has not yet taken one of the surveys.

5) Challenge Smart Task has a set of mini-challenges that each trigger randomly (e.g., with a probability 0.2). In another embodiment, these mini-challenges can use the results of the survey to trigger a few of the challenges conditionally. Some of the mini-challenges, such as walking for 5 minutes, involve automatic exercise tracking.

The set of smart tasks described above is obviously not exhaustive, is specific to each goal, and is under constant improvement and development.

Automated Learning in Task Generation. The task-based system allows for efficient learning based on task assignment and subsequent compliance and progress on desired outcomes. The selection module 208 may use reinforcement learning (RL). For example, the selection module 208 may compute the impact of a particular goal assignment on compliance level over the next two week period. This serves as an approximation for global compliance and outcome progress. In another embodiment, the selection module 208 may compute the impact of an assignment of a set of goals (a regimen) on the outcomes.

As another example, the selection module 208 may inject a particular new experimental task into an experimental group of people, and then monitor the impact of inserting this task versus the control group.

Human-Aided Goal Generation and Coach Messaging. The selection module 208 may automate the task generation, journaling and tracking that is part of an effective electronic health program, as described above. However, the invention may also enable human interactivity in various circumstances, such as when a user requests additional help, gets stuck on a plateau before reaching the desired goal, or otherwise requires a function not allowed for in the automatic regimen.

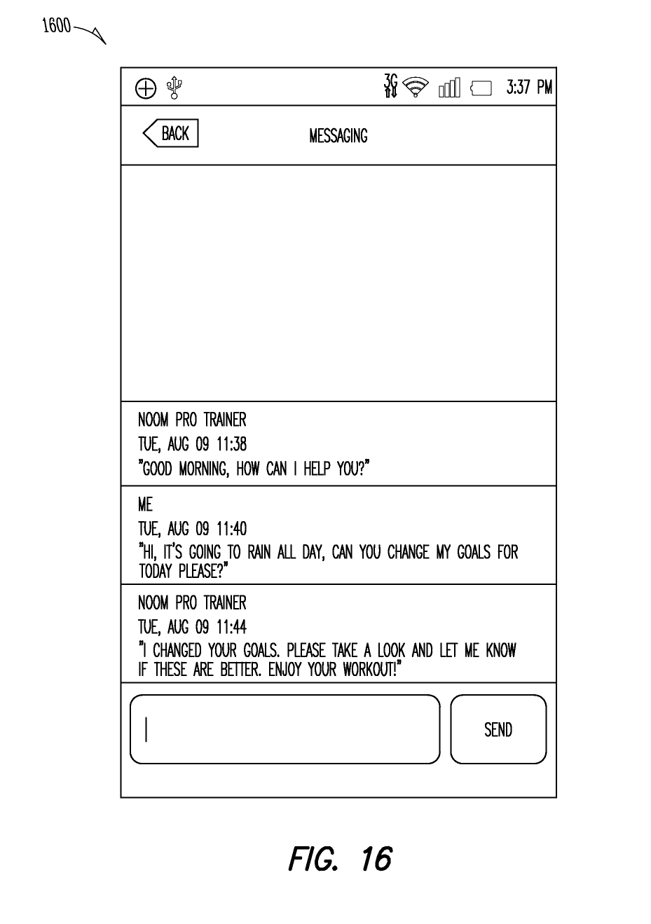

The communication module 210 may enable human interactivity in various forms, such as human messaging or manual task adjustment. In terms of human messaging, the communication module 210 may enable both the user and the support coaching personnel to send short messages to each other (see FIG. 16). The messages may be designed to be short (e.g., less than 250 characters) in order to, for example, discourage users from supplying too much unstructured and thus difficult-to-process information to the system. For example, most information about the user may be collected by the collection module 206 through appropriate explicit data collection tasks designed just for that purpose.

In terms of manual task adjustment, the selection module 208 may enable human coaching personnel to adjust tasks that the user is receiving. This adjustment might be triggered by a user's request, or it might be triggered by an automated rule which alerts the human personnel to intervene. For example, a rule may specify that if a client has made less than 50% of planned progress towards the desired outcome two week in a row, human coaches are to be alerted. The human coaches can then create, delete, or modify any of the goals scheduled for that day or any future days for that user.

The manual task adjustment and human messaging often work in concert with one another. For example if, as part of a weight loss program, a human coach wants to know which vegetables a person likes, the coach would then insert that explicit data collection task into the system (e.g., via the selection module 208) and then inform the user (e.g., via the communication module 210) about why they are asking this. This creates a powerful combination that does not require much human intervention, yet still produces a “warm” feeling of human involvement and accountability.

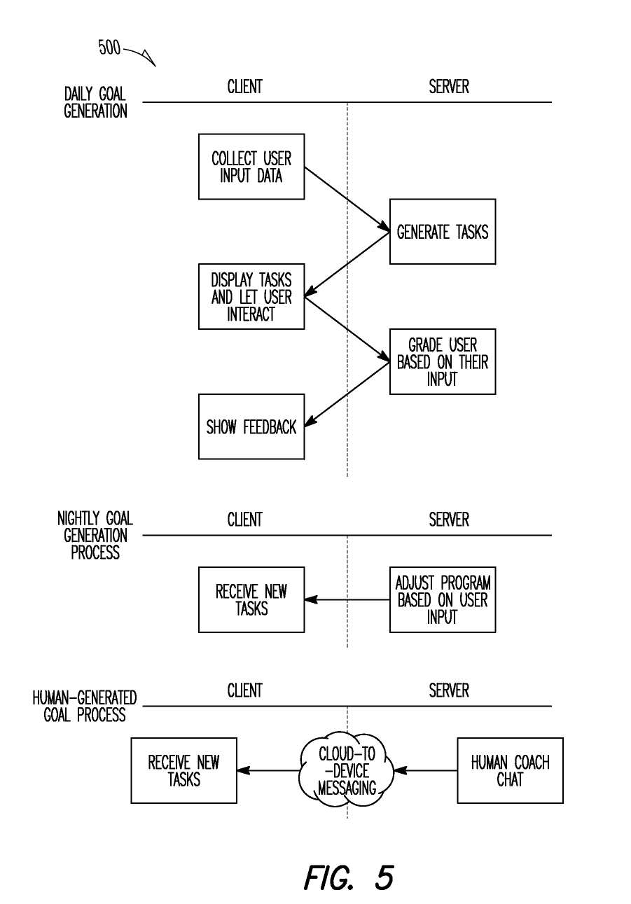

FIG. 5 depicts example interactions 500 between a client (e.g., the client 128, 106, or 108) and a server (e.g., the server 118) in automatic (e.g., daily and nightly) goal generation and human-generated goal generation. In performing daily goal generation, the client may collect user input data (e.g., via a user interface presented by the client in response to instructions received from the server). In response, the server may generate tasks (e.g., via the selection module 208). In response, the client may display the tasks and let the user interact with the tasks (e.g., enter data pertaining to the tasks) (e.g., via the user interface). In response, the server may grade the user based on their input (e.g., via the grading module 204).

In performing nightly goal generation, the server may adjust the program based on information received about the user (e.g., via the collection module 206). In response, the client may receive the new tasks and present them to the user (e.g., via the user interface).

In implementing human-generated goals, a human coach may provide inputs to the applications 120 to add a human touch to an otherwise automated process (e.g., by communicating with the user via the communication module 210 or manually suggesting a task for the user to perform via the selection module 208).

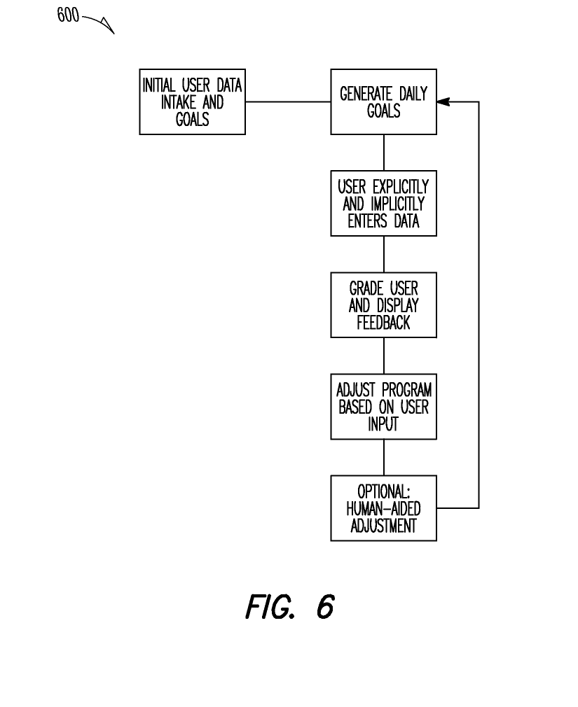

FIG. 6 is a block diagram depicting an example flow 600 of the applications 120, which are configured to implement a task-based electronic health program. There is an intake of initial user data and goals. Daily goals are generated. The user explicitly or implicitly enters additional data. The user is graded (e.g., on how he does in completing a daily goal) and feedback is displayed (e.g., on a client device of the user). The electronic health program is adjusted for the user based on the explicitly or implicitly received data. Optionally, the adjustment is aided by a human (e.g., a personal coach of the user).

FIG. 7 is a screenshot of an example user interface 700 of applications 120 (e.g., presented via a client executing on a client device). The user interface 700 presents the user with information concerning his health program, such as his suggested tasks and his progress toward completing his suggested tasks or goal.

FIG. 8 is a screenshot of an example user interface 800 of applications 120 (e.g., presented via a client executing on a client device). The user interface 800 prompts the user to provide detailed information regarding what he has eaten.

FIG. 9 is a screenshot of an example user interface 900 of applications 120 (e.g., presented via a client executing on a client device). The user interface 900 prompts the user to provide information regarding what he has eaten in a less-detailed form than the user interface 800.

FIG. 10 is a screenshot of an example user interface 1000 of applications 120 (e.g., presented via a client executing on a client device). The user interface 1000 prompts the user to enter information regarding his exercise activities. The user interface 1000 may be configured to prompt the user for very detailed information or less detailed information.

FIG. 11 is a screenshot of an example user interface 1100 of applications 120 (e.g., presented via a client executing on a client device). The user interface 1100 depicts an implicit gathering of information by the applications 120 with respect to a running workout performed by the user. In various embodiments, the user may not be prompted to explicitly enter information about the running workout.

FIG. 12 is a screenshot of an example user interface 1200 of applications 120 (e.g., presented via a client executing on a client device). The user interface 1200 presents the user with an exercise task to perform and enables the user to specify whether he has completed the task.

FIG. 13 is a screenshot of an example user interface 1300 of applications 120 (e.g., presented via a client executing on a client device). The user interface presents the user with a mini-article task to perform and enables the user to specify whether he has completed the task. The task may be selected by the selection module 208 based on the task having a different type than a type of an additional task that was previously suggested to the user.

FIG. 14 is a screenshot of an example user interface 1400 of applications 120 (e.g., presented via a client executing on a client device). The user interface 1400 prompts the user to commit to performing a task in the future.

FIG. 15 is a screenshot of an example user interface 1500 of applications 120 (e.g., presented via a client executing on a client device). The user interface 1500 includes a widget that is displayed outside of the context of the user accessing the applications 120.

FIG. 16 is a screenshot of an example user interface 1600 of applications 120 (e.g., presented via a client executing on a client device). The user interface 1600 enables the user to communicate directly with a human trainer (e.g., via the communication module 210).

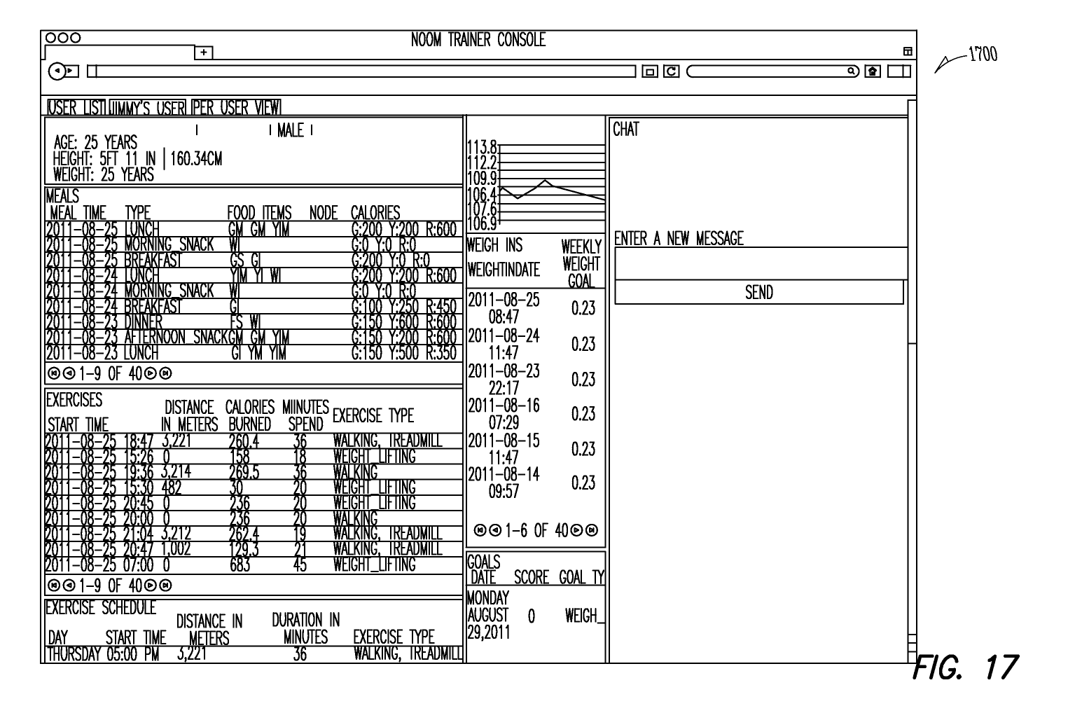

FIG. 17 is a screenshot of an example user interface 1700 of applications 120 (e.g., presented via a client executing on a client device). The user interface 1700 may be presented as an internal console to a human trainer who is responsible for monitoring a progress of a user toward completing a task or goal. The human trainer may use the information in the console to interact directly with the user (e.g., to send a message to a user or to suggest a task to the user).

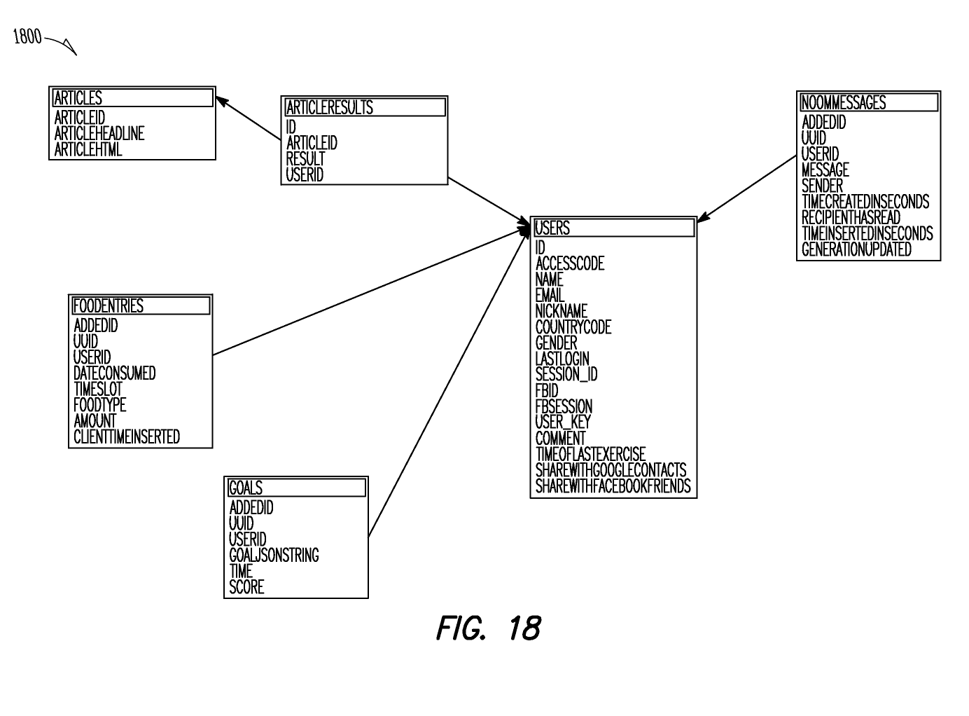

FIG. 18 is a block diagram depicting example relationships 1800 between tables of databases used by the applications 120 (e.g., the database 126). The tables include articles, article results, food entries, goals, users, and NoomMessages (e.g., messages communicated between the user and applications 120 with or without interaction with a human trainer).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 120) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

FIG. 19 is a block diagram of machine in the example form of a computer system 1900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a mobile phone (e.g., an iPhone or a mobile phone executing an Android operating system), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor 1902 (e.g., a central processing unit (CPU), a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alphanumeric input device 1912 (e.g., a keyboard), a user interface (UI) navigation (or cursor control) device 1914 (e.g., a mouse), a disk drive unit 1916, a signal generation device 1918 (e.g., a speaker) and a network interface device 1920.

The disk drive unit 1916 includes a machine-readable medium 1922 on which is stored one or more sets of instructions and data structures (e.g., software) 1924 embodying or utilized by any one or more of the methodologies or functions described herein. The instructions 1924 may also reside, completely or at least partially, within the main memory 1904 and/or within the processor 1902 during execution thereof by the computer system 1900, the main memory 1904 and the processor 1902 also constituting machine-readable media. The instructions 1924 may also reside, completely or at least partially, within the static memory 1906.

While the machine-readable medium 1922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1924 may further be transmitted or received over a communications network 1926 using a transmission medium. The instructions 1924 may be transmitted using the network interface device 1920 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1926 may be one of the networks 120.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a processor-implemented module configured to:
determine a goal of a user, the goal pertaining to health of the user;
identify information to collect to determine a progress of the user toward accomplishing the goal of the user;
select a level of specificity at which to prompt the user to provide a portion of the information;
prompt the user to provide the portion of the information at the level of specificity; and
determine a progress of the user toward accomplishing the goal based on the portion of the information.

2. The system of claim 1, wherein the processor-implemented module is further configured to identify a periodicity at which to prompt the user to provide the portion of the information at the level of specificity, wherein the prompting of the user to provide the portion of the information is further based on the periodicity at which to prompt the user to provide the portion of the information at the level of specificity.

3. The system of claim 2, wherein the processor-implemented module is further configured to collect an additional portion of the information, wherein at least one of the selecting of the level of specificity and the identifying of the periodicity is based on the additional portion of the information.

4. The system of claim 3, wherein the collecting of the additional portion of the information includes accessing information collected by a sensor of a device associated with the user.

5. The system of claim 4, wherein the sensor is a weight sensor and the additional portion of the information is the weight of the user.

6. The system of claim 1, wherein the processor-implemented module is further configured to:
generate a plurality of tasks based on the goal of the user;
provide a recommendation that the user completes a task of the plurality of tasks, the task having a type;
select an additional task of the plurality of tasks based on the additional task having an additional type; and
provide a recommendation that the user completes the additional task.

7. The system of claim 1, wherein the type is one of data collecting, manual journaling, automatic tracking, mini-article reading, mini-challenge performing, and future committing.

8. A method comprising:
determining a goal of a user, the goal pertaining to health of the user;
identifying information to collect to determine a progress of the user toward accomplishing the goal of the user;
selecting a level of specificity at which to prompt the user to provide a portion of the information;
prompting the user to provide the portion of the information at the level of specificity; and
determining, using a processor, a progress of the user toward accomplishing the goal based on the portion of the information.

9. The method of claim 8, further comprising identifying a periodicity at which to prompt the user to provide the portion of the information at the level of specificity, wherein the prompting of the user to provide the portion of the information is further based on the periodicity at which to prompt the user to provide the portion of the information at the level of specificity.

10. The method of claim 9, further comprising collecting an additional portion of the information, wherein at least one of the selecting of the level of specificity and the identifying of the periodicity is based on the additional portion of the information.

11. The method of claim 10, wherein the collecting of the additional portion of the information includes accessing information collected by a sensor of a device associated with the user.

12. The method of claim 11, wherein the sensor is a weight sensor and the additional portion of the information is the weight of the user.

13. The method of claim 8, further comprising:
generating a plurality of tasks based on the goal of the user;
providing a recommendation that the user completes a task of the plurality of tasks, the task having a type;
selecting an additional task of the plurality of tasks based on the additional task having an additional type; and
providing a recommendation that the user completes the additional task.

14. The method of claim 9, wherein the type is one of data collecting, manual journaling, automatic tracking, mini-article reading, mini-challenge performing, and future committing.

15. A non-transitory machine readable storage medium storing a set of instructions that, when executed by at least one processor, causes the at least one processor to perform a method, the method comprising:
determining a goal of a user, the goal pertaining to health of the user;
identifying information to collect to determine a progress of the user toward accomplishing the goal of the user;
selecting a level of specificity at which to prompt the user to provide a portion of the information;
prompting the user to provide the portion of the information at the level of specificity; and
determining a progress of the user toward accomplishing the goal based on the portion of the information.

16. The non-transitory machine readable storage medium of claim 15, the method further comprising identifying a periodicity at which to prompt the user to provide the portion of the information at the level of specificity, wherein the prompting of the user to provide the portion of the information is further based on the periodicity at which to prompt the user to provide the portion of the information at the level of specificity.

17. The non-transitory machine readable storage medium of claim 16, the method further comprising collecting an additional portion of the information, wherein at least one of the selecting of the level of specificity and the identifying of the periodicity is based on the additional portion of the information.

18. The non-transitory machine readable storage medium of claim 17, wherein the collecting of the additional portion of the information includes accessing information collected by a sensor of a device associated with the user.

19. The non-transitory machine readable storage medium of claim 18, wherein the sensor is a weight sensor and the additional portion of the information is the weight of the user.

20. The non-transitory machine readable storage medium of claim 15, the method further comprising:
generating a plurality of tasks based on the goal of the user;
providing a recommendation that the user completes a task of the plurality of tasks, the task having a type;
selecting an additional task of the plurality of tasks based on the additional task having an additional type; and
providing a recommendation that the user completes the additional task.
